(19) United States
(12) Patent Application Publication
(10) Pub. No.: US 2026/0083103 A1
(43) Pub. Date: Mar. 26, 2026

(54) Device and method for guiding and transferring fish and liquid out of a tank

(71) Applicant: SEARAS AS, Bergen (NO)

(72) Inventor: Morten AGA, Bergen (NO)

(73) Assignee: SEARAS AS, Bergen (NO)

(21) Appl. No.: 19/103,362

(22) PCT Filed: Aug. 14, 2023
(86) PCT No.: PCT/NO2023/000002

§ 371 Date: Feb. 12, 2025

(30) Foreign Application Priority Data
Aug. 15, 2022 (NO) 20220882

(51) Int. Cl. A01K 61/90; A01K 29/00; A01K 61/10; A01K 63/00

(52) U.S. Cl. CPC A01K 61/90; A01K 29/005; A01K 61/10; A01K 63/00

(57) ABSTRACT

Disclosed is an apparatus and a method for guiding and transferring marine organisms, such as fish, from a fish tank using a suction system coupled to the center part of a horizontally positioned guiding grid that moves upward in the water space in the fish tank. The fish will seek downwards and into the suction arrangement and be transferred to another tank.

### FIELD OF THE INVENTION

The present invention relates to a device and a method for guiding and transferring marine organisms, such as fish, in a liquid in a tank. Preferably, the tank is circular, such as a breeding tank for marine organisms.

### BACKGROUND OF THE INVENTION

With the environmental challenges faced in today's open-sea farming of marine species, more and more production will need to take place in closed tanks. Demands for increased production and yield mean that the tanks are getting larger, and to maximize their use, fish must be moved from tank to tank as they grow. The water, i.e., the liquid the marine organism resides in, is valuable, and one cannot afford to drain such large tanks to relocate the fish. The water must, therefore, be transferred along with the fish to a new tank while maintaining the tank levels. Moving fish is becoming an increasingly important part of the operation of a fish farm as the facilities grow larger, aiming to maximize the tank volumes for production, thus having the highest possible biomass at all times in the tank.

The movement of marine organisms, such as fish, can be divided into 2 stages: first, fish needs to be guided to a suitable location in the tank, and then it is moved or transferred to another tank. The guiding itself is a critical operation since it triggers stress reactions in fish. This leads to increased oxygen consumption and the release of carbon dioxide, which is a significant stress factor for the fish. They tend to move downwards in the tank as it is an instinct that most fish species have. Therefore, it is essential to consider this in the design of mechanisms for guiding and leading fish out of the tank.

### DESCRIPTION OF PRIOR ART

Various solutions are available today for guiding of fish, where fish are directed into a piping system that takes them further out of the tank. In sea cages, herding nets are commonly used to gather fish in bags where they are sucked up and into a fish pump. This type of guiding system causes a lot of stress to the fish and results in high mortality. In closed tanks, various methods are used, ranging from draining the water to various forms of guiding partitions that press the fish into an increasingly smaller sector from which they are pumped out. The best solutions push the fish towards the tank's bottom and suck them out through a hole in the tank wall. A typical example of this is shown in patent application PCT/NO2021/050275 and in NO324024.

In NO324024, MMC Tendos AS describes a solution for guiding fish in cylindrical tanks, primarily intended for use in wellboats that transport fish. Issues related to flow conditions and sedimentation of particles in the tanks on such wellboats are not as relevant to the present invention. The solution is based on upwardly directed profiles mounted on or near the tank's bottom, and a grid designed in approximately the same shape as the tank is lowered towards these upwardly directed profiles. When the grid reaches the same height as these upwardly directed profiles, one of the upwardly directed profiles rotates around the tank's center, pushing the fish into a small sector. The exit out of the tank is in the tank wall in this sector, and the fish are finally pushed out through the hole in the tank wall for transfer to a new container.

This solution has several disadvantages, especially in tanks where the fish will stay for a while and where they will also be fed. The upwardly directed profiles at the bottom will affect the flow pattern in the tank, causing sedimentation of fish waste and feed residues around these profiles. This is a significant disadvantage in tanks where large amounts of fish need to be produced. Additionally, taking the fish out through a hole in the tank wall near the bottom is problematic for cleaning since this is often embedded in the ground, making it difficult to clean and causing stagnant water that can easily develop hydrogen sulfide, which is highly toxic to fish.

### OBJECT OF THE INVENTION

The object of the invention is to provide a system (a device and method) for gathering fish and leading them into a piping system for transfer to another tank. It is an object of the invention to do this gently, preferably more gently than with known methods and devices. It is an object to consider the fish's natural response pattern as they seek the bottom when frightened. Additionally, it is an object of the invention not to have penetrations in the tank wall below the water level.

The patent applicant has various patents and patent applications related to closed tank solutions, emphasizing the importance of having clean and smooth interior surfaces inside the tank, without objects that disturb the flow pattern and create sedimentation of particles. A clean cylindrical tank without installations on the interior surfaces, providing good tank hydraulics, is crucial for efficient aquaculture in closed tanks. Likewise, the mechanism for guiding the fish should be reliable and easy to handle since guiding and moving fish occur frequently. The solution should also be operable while water circulates in the tank. The water speed in the tank can typically be around 0.5 m/s, which can exert significant forces on objects used for guiding fish.

### SUMMARY OF THE INVENTION

The solution being patented consists of a horizontally arranged guiding grid, in the form of a perforated lid that can move up and down around the center column in the tank. This grid is in an inactive position positioned at the bottom of the tank, usually before the marine organisms are transferred to the tank. The guiding grid is perforated to allow water to flow through it and be sucked in under the grid and into the center column. This ensures that there is no sedimentation of particles under the grid. Fish that die will accumulate on top of the grid and are periodically sucked towards the center column, into it, and out of the facility.

When fish need to be guided and transferred out of the tank, the guiding grid is moved from its inactive position at the bottom of the tank, vertically upward. A suction arrangement is lowered into the tank and positioned in the center, just above the guiding grid. The fish are herded to this position and are transferred out of the tank (moved to a new tank) via the suction arrangement. Preferably, the suction arrangement is connected to a siphon that lifts the marine organisms out of the tank through a flexible piping.

The present invention relates, in a first aspect, to a device for guiding and transferring live marine organisms from a tank, wherein the device includes at least one suction arrangement for the removal of liquid and marine organisms and a horizontally arranged perforated guiding grid, wherein the suction arrangement is centrally positioned directly above the horizontally perforated guiding grid, and the guiding grid is designed to be raised from an inactive position at the bottom of the tank and vertically upward to herd liquid and marine organisms out of the tank via the suction arrangement.

In one embodiment, the guiding grid is raised in the tank simultaneously with a constant water flow being introduced into and up through the suction arrangement.

In one embodiment, the guiding grid is moved vertically up and down in the tank, movably attached to vertical guides along the center column and tank wall.

In one embodiment, the guiding grid includes a channel in the center, configured to direct fish toward this channel when the guiding grid moves upward.

In one embodiment, the guiding grid's channel includes, in at least one section, a recess.

In one embodiment, the suction arrangement is positioned in said recess.

In one embodiment, the suction arrangement is positioned in said channel.

In one embodiment, the guiding grid is constructed as a framework with an inner and outer ring, with soft, flexible, plastic-like lamellae against the tank wall and center column.

In one embodiment, the guiding grid is designed so that the center of the guiding grid and the suction arrangement are positioned vertically lower than the outer edge of the guiding grid.

In one embodiment, the guiding grid is made of mesh, grating, or lattice material with openings tailored to the size of the marine organisms in the tank, allowing liquid to flow freely through the guiding grid while preventing the organisms from passing through the grid's openings.

In one embodiment, the suction arrangement is connected to a siphon that lifts the marine organisms out of the tank through a flexible piping.

In one embodiment, the stress level and position of the marine organisms are monitored, and this information is used to control the elevation of the horizontal guiding grid.

In one embodiment, visual and acoustic methods, such as cameras, hydrophones, and/or radar, are used to monitor the stress level and position of the marine organisms. If it is found that the fish are stressed or located in the wrong place in the tank, the movement of the guiding grid is slowed down or stopped.

In a second aspect, the present invention relates to a method for guiding marine organisms in a tank. The method involves moving a horizontally arranged guiding grid upward in the water column while a suction arrangement located just above the guiding grid sucks water and marine organisms out of the tank as they migrate towards the center of the guiding grid.

In one embodiment, the guiding grid is moved from an inactive low position in the tank and upward in the tank to guid the marine organisms towards the center and into a location just above the guiding grid.

In one embodiment, the guiding grid, in its innermost edge portion, is equipped with a channel, and during herding, the upward movement of the guiding grid directs fish toward this channel.

In one embodiment, said channel is equipped with at least one recess such that during guiding, fish are directed into this recess, and the suction arrangement is positioned in this recess.

### DESCRIPTION OF FIGURES

Preferred embodiments of the invention will be described in more detail below with reference to the accompanying figures, where:

FIG. 1 schematically shows a tank for breeding marine organisms with a guiding grid in an inactive lower position. When fish need to be guided out of the tank, the guiding grid is moved upward, and the fish will be directed towards the guiding grid's channel and recess towards the suction arrangement.

FIG. 2 schematically shows the same tank as in FIG. 1, but with the guiding grid in an upper position.

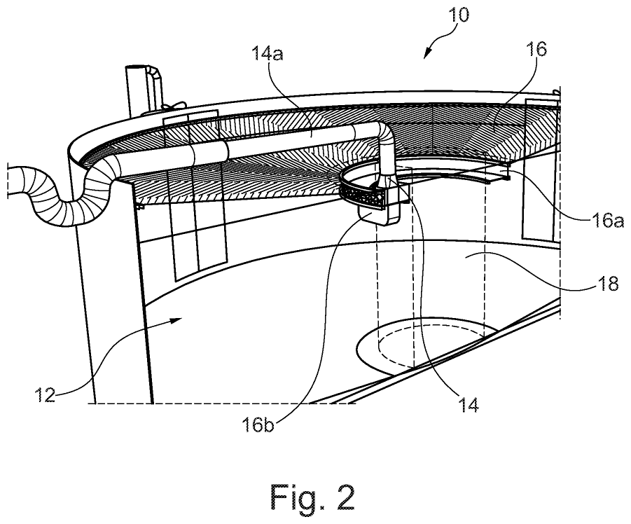

FIG. 3a shows a tank with one suction arrangement, while FIG. 3b shows a tank with two suction arrangements.

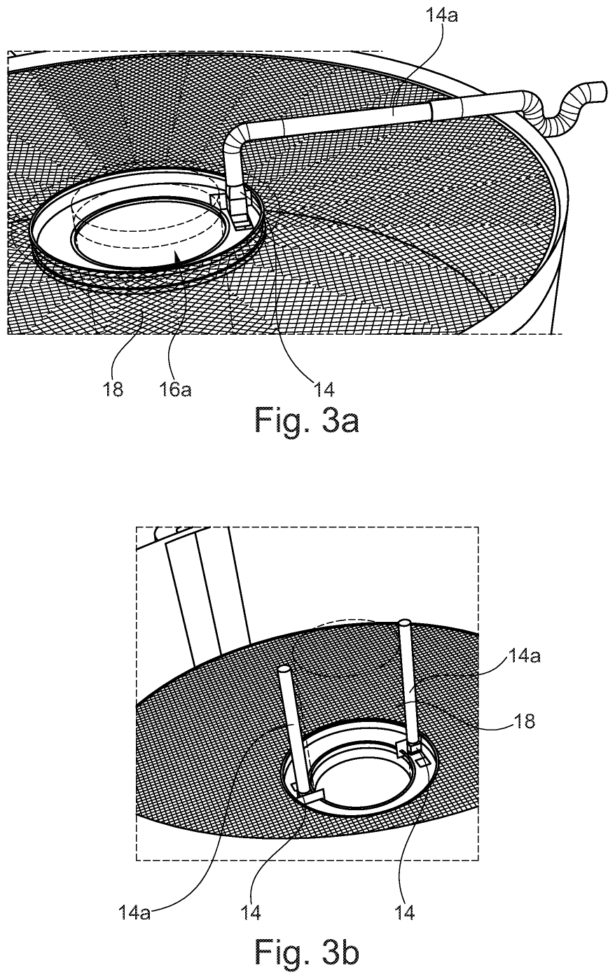

### DETAILED DESCRIPTION OF PREFERRED EMBODIMENTS OF THE INVENTION

The principle underlying the present invention is that the opening through which the marine organisms are to be transferred from the aquaculture tank 12 moves with the movement of the guiding grid 16, i.e., it is positioned just above, and at the center (outside the center column 18) of the guiding grid 16. A suction arrangement 14 is located near this opening.

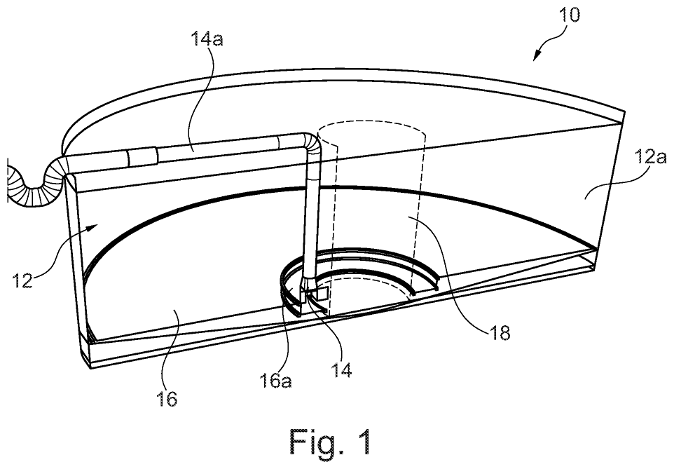

As shown in FIG. 1, the device for guiding and transferring fish (as an example of marine organisms) includes a guiding grid 16 and a suction arrangement 16 that work together. In FIG. 1, the guiding grid 16 is shown in its lower inactive position, and when it needs to guid the fish to transfer them to a new tank, the guiding grid is moved upward simultaneously with the suction arrangement 14. The suction arrangement 14, therefore, has a flexible pipeline, such as a hose.

The guiding grid 16 is permeable to liquid, meaning that the water in which the fish reside flows freely through the guiding grid 16. The openings in the guiding grid are small enough to prevent the marine organisms from moving from one side of the grid to the other.

The guiding grid is attached to the tank wall 12a and outer sides of the center column 18 via guiding elements on the tank wall 12a and center column 18, respectively. These guides (guiding elements) are not shown in detail in the figure but can be in the form of slots in which pins on the grid are vertically moved up and down.

In a preferred embodiment, the guiding grid 16 is vertically higher in the outer periphery than in the center so that the guiding grid is sloping towards the center of the tank. This arrangement will cause the fish, during herding, to be directed towards the center. The guiding grid preferably consists of an outer ring and an inner ring, where the outer ring is higher than the inner ring. When the grid is raised in the tank 12, the fish may feel threatened and move towards it, being led towards the center and into the suction of the flexible pipe and carried up and out of the tank 12. This design also ensures that when the guiding grid 16 comes all the way up, the last remaining fish will be drawn towards the center and into the channel 16a and sucked up.

In a preferred embodiment, the suction arrangement is connected to a siphon so that the siphon principle is used to guide the fish out of the tank 12. Alternatively, or in combination, the fish can be sucked out of the tank using a pump.

Preferably, the guiding grid, near the center, is equipped with a circular channel 16a. During guiding, the fish will be directed towards and seek down into this channel 16a. Preferably, the channel 16a is equipped with one or more recesses 16b, and the suction arrangement is preferably located in one or more of these recesses 16b.

With this solution, it has been achieved that fish can be gently guided out of a tank, and possibly transferred to a new tank, by raising a guiding grid 16 in the tank 12. The guiding will cause the fish to gather just above the guiding grid 16 and the center of the tank. They are then led through the channel 16a, preferably a recess 16b, to the suction arrangement 14, which guides the fish out of the tank 12. Since the solution is very gentle on the fish, it is especially suitable for tanks where the fish will stay for shorter periods, e.g., for slaughter tanks.

1. A device for the harvesting and transfer of live marine organisms from a tank, wherein the device comprises at least one suction arrangement for the removal of liquid and marine organisms and a horizontally arranged perforated guiding grid, wherein the suction arrangement is centrally positioned directly above the horizontally perforated guiding grid, and the guiding grid is designed to be raised from an inactive position at the bottom of the tank and vertically upward for the guiding of liquid and marine organisms out of the tank via the suction arrangement.

2. The device according to claim 1, wherein the guiding grid is raised in the tank simultaneously with a constant water flow being introduced into and up through the suction arrangement.

3. The device according to claim 1, wherein the guiding grid is moved vertically up and down in the tank movably attached to vertical guides along a center column and a tank wall.

4. The device according to claim 1, wherein the guiding grid has a central channel, configured to direct the marine organisms towards this channel when the guiding grid moves upward.

5. The device according to claim 4, wherein the guiding grid's central channel comprises at least one recess.

6. The device according to claim 5, wherein the suction arrangement is arranged in said recess.

7. The device according to claim 5, wherein the suction arrangement is located in said central channel.

8. The device according to claim 3, wherein the guiding grid is constructed as a framework with an inner and outer ring with soft flexible plastic-like lamellae against the tank wall and the center column.

9. The device according to claim 1, wherein the guiding grid is designed so that the center of the guiding grid and the suction arrangement are positioned vertically lower than an outer edge of the guiding grid.

10. The device according to claim 2, wherein the guiding grid has a grid structure of mesh, grating, or lattice material with openings tailored to the size of the marine organisms in the tank, allowing the marine organisms to pass through the openings of the guiding grid, while the liquid freely flows through the guiding grid.

11. The device according to claim 1, wherein the suction arrangement is connected to a pump that lifts the marine organisms out of the tank through a flexible piping.

12. The device according to claim 1, wherein stress level and position of the marine organisms are monitored, and this information is used to control elevation of the horizontal guiding grid.

13. The device according to claim 12, wherein visual and acoustic methods, such as cameras, hydrophones, and/or radar, are used to monitor the stress level and position of the marine organisms.

14. A method for guiding marine organisms in a tank, the method comprising:
moving a horizontally arranged guiding grid upward in a water column, and
drawing water and marine organisms out of the tank with a suction arrangement as the water and marine organisms migrate towards the center of the guiding grid,
wherein the suction arrangement is located just above the guiding grid.

15. The method according to claim 14, wherein the guiding grid is moved from an inactive low position in the tank and upward in the tank to guide the marine organisms towards the center and in a location just above the guiding grid.

16. The method according to claim 14, wherein the guiding grid, in its innermost edge portion, is equipped with a channel, and during guiding, the upward movement of the guiding grid guides the marine organisms towards this channel.

17. The method according to claim 16, wherein said channel is equipped with at least one recess such that during guiding, the marine organisms are directed into this recess, and the suction arrangement is positioned in this recess.
